(19) United States
(12) Patent Application Publication
(10) Pub. No.: US 2004/0125754 A1
(43) Pub. Date: Jul. 1, 2004

(54) Method and apparatus for integrating non-IP and IP traffic on a home network

(75) Inventor: Gerald Johnson, Cataumet, MA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/632,676

(22) Filed: Aug. 1, 2003

Related U.S. Application Data
(60) Provisional application No. 60/400,186, filed on Aug. 1, 2002.

(51) Int. Cl. H04L 12/28

(52) U.S. Cl. 370/257; 370/395.5

(57) ABSTRACT

A method and apparatus for distributing broadcast quality video (or similar timing critical data) in the home over a network that is also carrying IP traffic integrates non-IP video traffic with IP traffic in a seamless manner. The present invention provides a method and apparatus for creating a network with mixed traffic, e.g., both timing critical traffic, such as MPEG type traffic, and IP traffic. The method transmits the timing critical data directly to a Media Access Control (MAC) layer and adds one or more specific functions to the Media Access Control to maintain timing restrictions of the timing critical data. The timing critical data can include an MPEG video data stream, and the one or more specific functions are then one or more MPEG specific functions. An exemplary embodiment of a method for transmitting timing critical data, such as MPEG video data or 1394 traffic including isochronous video data, includes transmitting the timing critical data directly to a MAC layer, maintaining a timing relationship of the timing critical data throughout the MAC layer to a scheduler, and using a single scheduler to schedule transmission of both the timing critical data and the Internet Protocol traffic.

### RELATED APPLICATIONS

This application claims priority to U.S. Provisional Patent Application No. 60/400,186 filed on Aug. 1, 2002 by the same inventor.

### FIELD OF THE INVENTION

The present invention is directed to methods and apparatuses distributing information over computer networks, and more particularly to a method and apparatus for distributing information, such as video data, over a computer network, including a home wired or wireless network.

### BACKGROUND

Many home users are establishing networks (both wired and wireless) in their homes to link multiple computers and other devices together. Typically these home networks are Internet Protocol (IP) based networks. In addition, home users are often coupled to the Internet via a fast or wide bandwidth connection, such as Digital Subscriber Link service, Cable Modem service or some other type of high-speed data service.

With the increase of high speed Internet access or digital television via cable or other media users will desire to transmit video or other timing critical data over their home networks. Yet, video data is often transmitted in MPEG format, which is not necessarily compatible with IP networks due to the timing considerations inherent in high quality video.

The present invention is therefore directed to the problem of developing a method and apparatus for distributing broadcast quality video (or similar timing critical data) in the home over a network that is also carrying IP traffic.

### SUMMARY OF THE INVENTION

The present invention solves these and other problems by providing inter alia a method and apparatus for integrating non-IP video traffic with IP traffic in a seamless manner. In addition, the present invention provides a method and apparatus for creating a network with mixed traffic, e.g., both timing critical traffic, such as MPEG type traffic, and IP traffic.

According to one aspect of the present invention, an exemplary embodiment of a method for transmitting timing critical data over a network that is also carrying Internet Protocol traffic includes transmitting the timing critical data directly to a Media Access Control layer while maintaining a timing relationship of the timing critical data throughout the Media Access Control layer to a scheduler that schedules transmission of both the timing critical data and the Internet Protocol traffic over the network, thereby ensuring proper timing of the timing critical data upon receipt at a client coupled to the network.

According to another aspect of the present invention, the timing critical data can include an MPEG video data stream, 1394 traffic containing isochronous video data, or other data in which the timing relationship between the packets must be maintained.

According to yet another aspect of the present invention, the network can include a wireless network, a home wireless network, a wired network or a home-wired network or other similar network.

According to still another aspect of the present invention, an exemplary embodiment of an apparatus to receive timing critical data from a first network and to transmit the timing critical data over one or more other networks to one or more client devices employs a video bridge. The video bridge couples to the first network, receives the timing critical data, maintains a timing relationship of the timing critical data and schedules transmission of the timing critical data over the one or more other networks.

According to another aspect of the present invention, an exemplary embodiment of the video bridge includes a first physical layer interface, a MAC receiver, one or more MAC transmitters, and one or more second physical layer interfaces. The first physical layer interface couples to the first network. The MAC receiver couples to the first physical layer interface and outputs the timing critical data. There is one MAC transmitter for each of the one of more client devices. Each MAC transmitter is coupled to the MAC receiver, receives the timing critical data and converts the timing critical data to a format suitable for transmission over one of the one or more other networks. There is one second physical layer interfaces for each of the one or more MAC transmitters. Each of the second physical layer interfaces is coupled to one of the one or more MAC transmitters and is coupled to the one of the one or more other networks.

According to still another aspect of the present invention, an exemplary embodiment of each of the one or more MAC transmitters includes one or more of the following: a PID filter, a timing circuit, a packetizer, a scheduler, and a queue. The timing circuit adjusts timing resulting from any filtering and adds additional timing information to adjust for latency and jitter introduced by the one of the one or more other networks. The packetizer is coupled to the timing circuit to create packets or frames that meet requirements of the one of the one or more other networks. The scheduler is coupled to the packetizer to schedule access to the one of the one or more other networks. The PID filter receives the timing critical data and filters out programs that are not required by one of the one or more client devices and outputs the filtered timing critical data to the timing circuit. The queue is coupled to the scheduler and buffers packets or frames prior to transmission over the one of the one or more other networks.

According to yet another aspect of the present invention, the apparatus may include one or more additional MAC receivers, one for each of the one or more client devices. Each of the one or more additional MAC receivers is disposed between one of the one or more other networks and one of the one or more client devices. An exemplary embodiment of each of the additional MAC receivers includes a depacketizer, a queue and a timing circuit. The depacketizer converts incoming packets to a format suitable for the timing critical data. The timing circuit is coupled to the depacketizer and restores the timing critical data based on bits added by a timing circuit in the one or more MAC transmitters. The queue is coupled to the depacketizer and buffers incoming packets from the one of the one or more other networks before passing the incoming packets to the depacketizer.

According to still another aspect of the present invention, an exemplary embodiment of an apparatus for transmitting a first timing critical data from a first network and a second timing critical data from a second network over one or more other networks to one or more client devices employs a video bridge. The video bridge is coupled to the first and second networks and receives the first and second timing critical data from the first and second networks, maintains a timing relationship of the first and second timing critical data and schedules transmission of the timing critical data over the one or more other networks to each of the one or more client devices.

According to still another aspect of the present invention, an exemplary embodiment of the video bridge includes two physical layer interfaces, two MAC receivers, a multiplexer and one or more MAC transmitters. In this exemplary embodiment, the multiplexer is coupled to the first and second MAC receivers and creates a single data stream from the first and second timing critical data, which is output to the one or more MAC transmitters, each of which receive the single data stream.

According to still another aspect of the present invention, an exemplary embodiment of the video bridge includes two physical layer interfaces, two MAC receivers, and one or more MAC transmitters. In this exemplary embodiment, each of the one or more MAC transmitters receives the first timing critical data and the second timing critical data, converts the first and second timing critical data to a format suitable for transmission over the one or more other networks, filters out programming not selected by said each of the one or more client devices, and schedules transmission of the filtered first and second timing critical data over the one or more other networks.

According to yet another aspect of the present invention, an exemplary embodiment of the MAC transmitter includes two PID filters, two timing circuits, two packetizers, a single scheduler and a single queue. The single scheduler is coupled to both of the two packetizers and schedules access the one of the one or more other networks.

According to still another aspect of the present invention, an exemplary embodiment of an apparatus for transmitting timing critical data from a first network over one or more other networks to one or more client devices employs a video bridge and a television. The video bridge is coupled to the first network and receives the timing critical data, maintains a timing relationship of the timing critical data, schedules transmission of the timing critical data over the one or more other networks, and outputs a television signal. The television is coupled to the video bridge and receives the television signal from the video bridge. In this case, the video bridge includes a decoder, which is coupled to the MAC receiver and the television and converts the timing critical data to a television signal.

According to yet another aspect of the present invention, an exemplary embodiment of an apparatus for transmitting timing critical data from a first network along with Internet Protocol packets over one or more other networks to one or more client devices includes a processor and a video bridge. The processor is outputting Internet Protocol data packets. The video bridge is coupled to the first network and the processor, receives the timing critical data, maintains a timing relationship of the timing critical data and schedules transmission of the timing critical data along with the Internet Protocol packets over the one or more other networks to the one or more client devices. In this case, at least one of the MAC transmitters includes a data port coupled to the processor to receive Internet Protocol packets. The data interface is coupled in parallel with the timing circuit to the scheduler to enable the scheduler to schedule access to the one of the one or more other networks for both Internet Protocol packets from the processor and the timing critical data.

According to still another aspect of the present invention, an exemplary embodiment of an apparatus for transmitting timing critical data from a first network along with Voice over Internet Protocol packets over one or more other networks to one or more client devices includes a media terminal adapter and a video bridge. The media terminal adapter has one or more telephone ports for coupling to a telephone device, and outputs voice over Internet Protocol packets. The video bridge is coupled to the first network and to the media terminal adapter, receives the timing critical data, receives the voice over Internet Protocol packets from the media terminal adapter, maintains a timing relationship of the timing critical data and schedules transmission of the timing critical data and the voice over Internet Protocol packets over the one or more other networks to the one or more client devices. In this case, at least one of the MAC transmitters includes a data port coupled to the processor to receive voice over Internet Protocol packets. The data interface is coupled in parallel with the timing circuit to the scheduler to enable the scheduler to schedule access to the one of the one or more other networks for both voice over Internet Protocol packets from the media terminal adapter and the timing critical data.

Other aspects of the present invention will be apparent to those of skill in the art upon review of the disclosure along with the following drawings.

### BRIEF DESCRIPTION OF THE DRAWINGS

FIG. 1 depicts an exemplary embodiment of an apparatus in which a set-top box is connected to a coaxial network and there is one television coupled to the set-top box via a wireless link according to one aspect of the present invention.

FIG. 2 depicts an exemplary embodiment of a video bridge for use in the apparatus of FIG. 1 according to another aspect of the present invention.

FIG. 3 depicts an exemplary embodiment of a detail of a MAC-T for use in the video bridge of FIG. 2 according to still another aspect of the present invention.

FIG. 4 depicts an exemplary embodiment of an apparatus for linking two televisions, one of which is wireless and the other of which is on a different coaxial network according to yet another aspect of the present invention.

FIG. 5 depicts an exemplary embodiment of a video bridge for use in the apparatus of FIG. 4 according to yet another aspect of the present invention.

FIG. 6 depicts an exemplary embodiment of an apparatus in which there are two servers feeding video that can be sourced to any of two or more clients on different sub networks according to still anther aspect of the present invention.

FIG. 7 depicts an exemplary embodiment of a video bridge for use in the apparatus of FIG. 6 according to yet another aspect of the present invention.

FIG. 8 depicts another exemplary embodiment of a video bridge for use in the apparatus of FIG. 6 according to yet another aspect of the present invention.

FIG. 9 depicts an exemplary embodiment of a detail of the MAC on the transport side for use in the video bridges of FIGS. 7-8 according to still another aspect of the present invention.

FIG. 10 depicts an exemplary embodiment of an apparatus in which there is a television co-located with the networking device according to still another aspect of the present invention.

FIG. 11 depicts an exemplary embodiment of an apparatus similar to that of FIG. 10, which has been extended to add Network Management capability an example of which would be that which CableHome specifies.

FIG. 12 depicts an exemplary embodiment of a detail of the transmit MAC for use in the apparatuses shown in FIGS. 10-11 according to still another aspect of the present invention.

FIG. 13 depicts an exemplary embodiment of an apparatus similar to that of FIG. 11 with data interfaces that are CableHome compliant interfaces according to still another aspect of the present invention.

FIG. 14 depicts an exemplary embodiment of an apparatus similar to that of FIG. 13 with voice capability according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Introduction

Successfully networking high quality broadcast video in the home requires special consideration. Converting an MPEG stream into packets and using Internet Protocols (IP) will not suffice except for the most rudimentary applications, as generally conversion to IP removes the timing relationship between successive packets. According to one aspect of the present invention, an exemplary embodiment for networking high quality broadcast video in the home delivers MPEG streams directly to the Media Access Control (MAC) layer and adds MPEG specific functions to the MAC in order to maintain MPEG timing restrictions. A common scheduler is then used to schedule access to the network for both the MPEG frames or packets and the IP packets, thereby ensuring that the timing relationship is maintained upon receipt at the client device that is coupled to the network.

One embodiment employs a single sub network in the home for all the MPEG video. However, in other embodiments MPEG video streams may be transmitted across multiple sub networks.

It should also be noted that 1394 traffic containing isochronous video information may be processed as is the MPEG herein. Therefore, the term timing critical data should be understood to include at least 1394 traffic containing isochronous video information, as well as other similar data.

Basic Video Networking

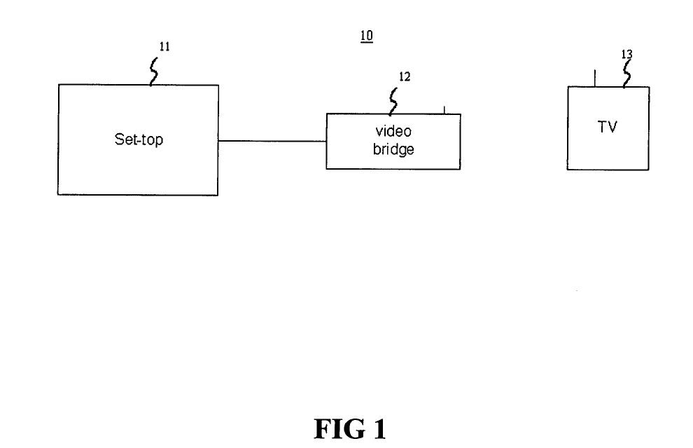

The most basic video-networking scenario is one where the play-out device is on a different subnet than the set-top box. For example, the set-top box 11 could be connected to a coaxial or hybrid fiber coaxial cable for delivering MPEG in the home, but there is one television 13 that is wireless. FIG. 1 depicts a network implementation 10 for this case. The signals between the set-top box and the television are packet/frame based network signals. In other words, these signals are data link layer signals. In this case, a video bridge 12 is used to bridge the video traffic from the coaxial network to the wireless network. The wireless network can be a home based wireless network operating in accordance with 802.11 (a) or 802.11 (b), for example.

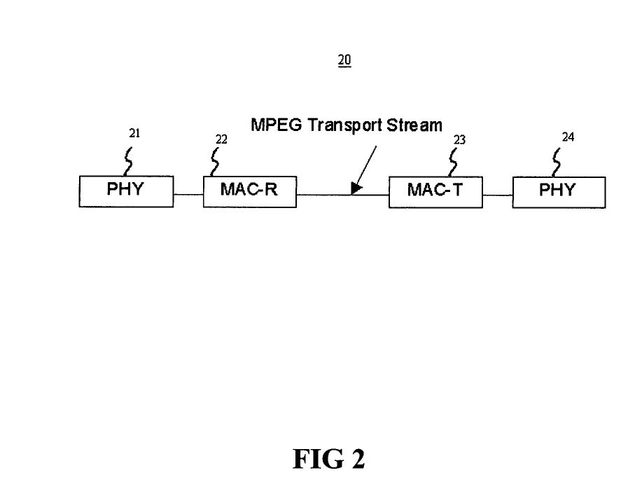

Shown in FIG. 2 is a high-level block diagram of an exemplary embodiment 20 of the video bridge 12. Essentially the MPEG transport stream output from the Media Access Controller (MAC) 22 on the coaxial network (MAC-R 22) is tied to the MPEG transport stream input on the MAC 23 on the wireless network (MAC-T 23), which in turn is tied to the physical layer interface 24 on the wireless network. The physical layer interface will be specific for each digital output from the set top box. Generally, this physical layer interface can include the electrical and mechanical aspects of the interface, e.g., a connector, such as a DVI cable connector or other similar connector. On the output side of the video bridge, the physical layer interface is the connector and any necessary electrical converter that would couple to the wireless transmitter of a wireless network, for example, an 802.11(a) or 802.11 (b) home network. In the case of a wired network, this connector would be specific for that network.

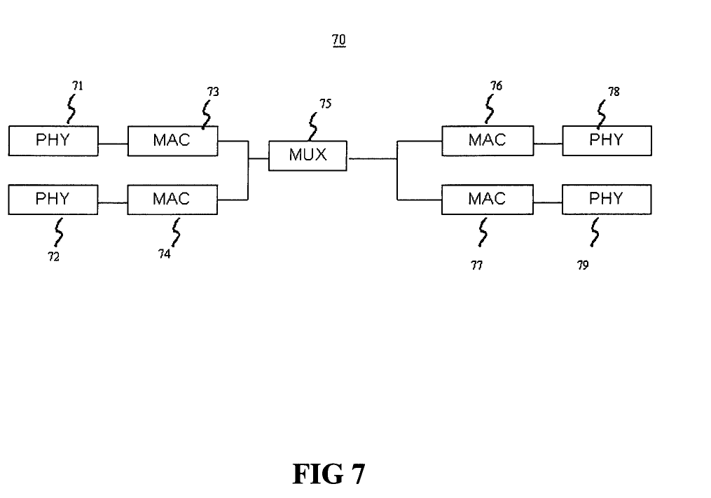

By moving many of the functions normally provided in networks into the MAC, the video bridge 12 of the present invention remains relatively simple in design, making this design practical for home based implementations. A demultiplexing block (not shown, but see FIG. 7, element 75) may be disposed between the MACs to filter any PIDs before they go to the MAC. Also, PID filtering could be performed in the MAC.

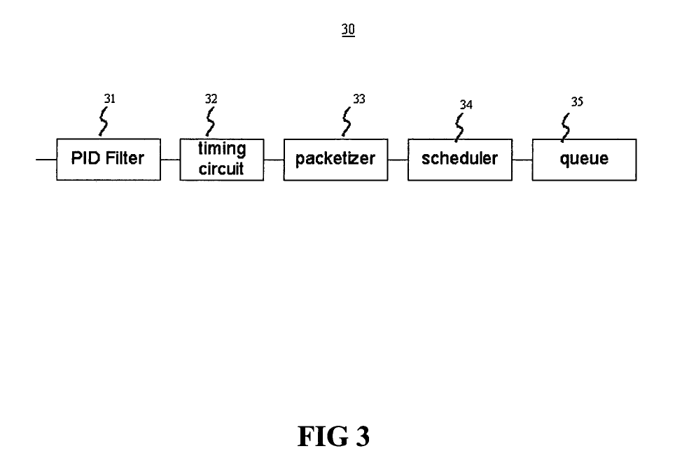

FIG. 3 depicts an exemplary embodiment 30 of a detail of a MAC-T 23 for use in the video bridge 12 of FIG. 2 according to still another aspect of the present invention. The first block is a PID filter 31, which filters out programs in the transport stream that are not required by the client on the wireless network. The PID Filter filters one or more specific packets (i.e., PIDs) from the MPEG stream. A typical MPEG stream is about 27 mbps containing multiple programs. Filtering out the specific program the user wants to watch greatly reduces the number of bits thereby conserving bandwidth on the home network.

The next block is a timing circuit 32 to adjust the MPEG timing as the result of the filtering and to add additional timing information that is used by the receiver to adjust for latency and jitter introduced by the wireless network. This timing circuit 32 adds additional bits to the packets so that the recipient of the packets can restore the MPEG stream to the original. On the transmit side, MPEG timing information might be augmented with additional timing information related to the home network. On the received side this information is synchronized with MPEG timing information to recover any timing slips that may have occurred.

The next block is the packetizer 33 that creates packets or frames that meet the requirements of the underlying network. The Home network itself generally has its own packet format. The packetizer takes the MPEG frames and puts them into frames suitable for the local home network. Additional header information may be included.

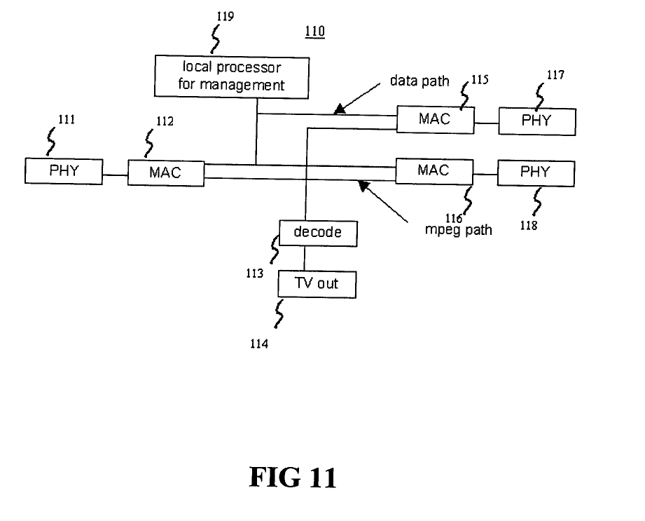

The next block is the scheduler 34, which schedules access to the network. In the case of multiple users attempting to access the network, the scheduler 34 becomes more important. The scheduler uses information in the MPEG header and home networking header to decide when each frame should be transmitted. In the case of more than one MPEG stream, the scheduler ensures that each frame is sent at the proper time, thereby maintaining the timing critical relationship of the MPEG stream all the way to the client device. In the case of data and voice traffic, the scheduler uses additional QoS signaling information received over the data interface to properly schedule video, voice and data over the same network (e.g., see FIGS. 11-14).

The last block is the queue 35, which is the final stage of the MAC. The queue is the buffer stage for the MAC as it sends and receives packets across the network.

On the MAC-R side (not shown), there is a queue block, followed by a De-Packetizer block, which in turn is followed by a timing circuit, which performs the restoration of the MPEG stream to its original based on the bits added by the timing circuit in the MAC-T timing circuit.

Networking Two Client Devices

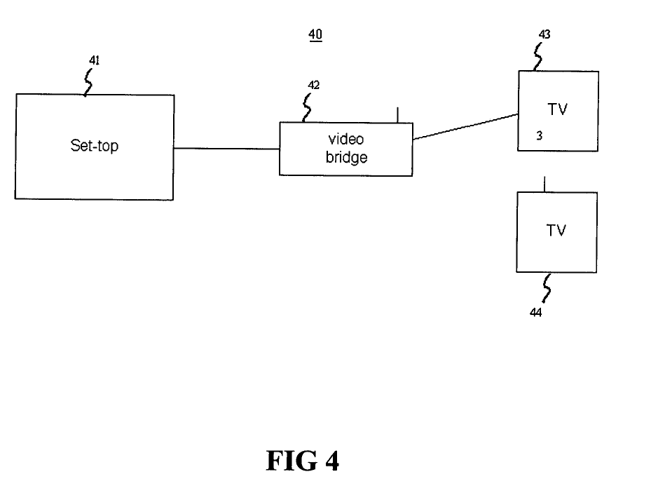

The next embodiment relates to the situation in which there are two client devices and these client devices are on different remote sub networks. One sub network may be wireless and the other may be a different coaxial network. In this case there is a need to send separate video streams to each of them. FIG. 4 depicts an exemplary embodiment of an apparatus 40 for linking two televisions 43, 44, one of which is coupled via a wireless connection 44 and the other 43 of which is coupled via a different coaxial network to set top box 41 according to yet another aspect of the present invention.

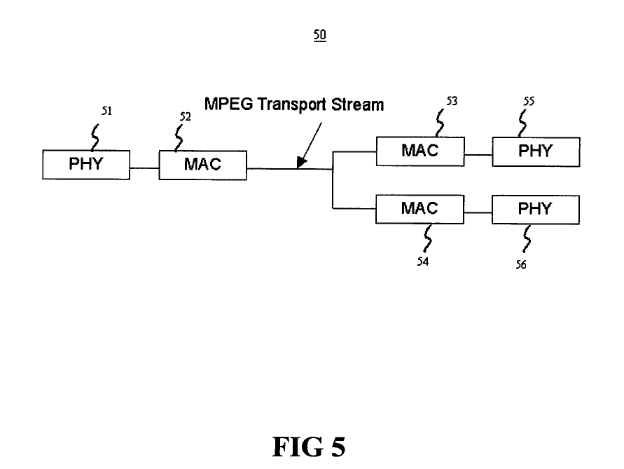

In this case the video bridge 42 feeds the MPEG transport streams to both sub networks. FIG. 5 depicts an exemplary embodiment 50 of a video bridge for use in the apparatus of FIG. 4 according to yet another aspect of the present invention. Basically, the same transport stream (i.e., the output from physical layer interface 51 and MAC 52) is fed into the MAC 53, 54 of each sub network, to which physical layer interfaces 55, 56 are coupled. Once again a PID filter can be used or the MAC can do the PID filtering. Moreover, any number of sub networks could be added using this same approach, e.g., 4, 8, 16, etc.

In this case, the MPEG stream is simply split into as many identical streams as there are sub networks.

Networking Two Servers

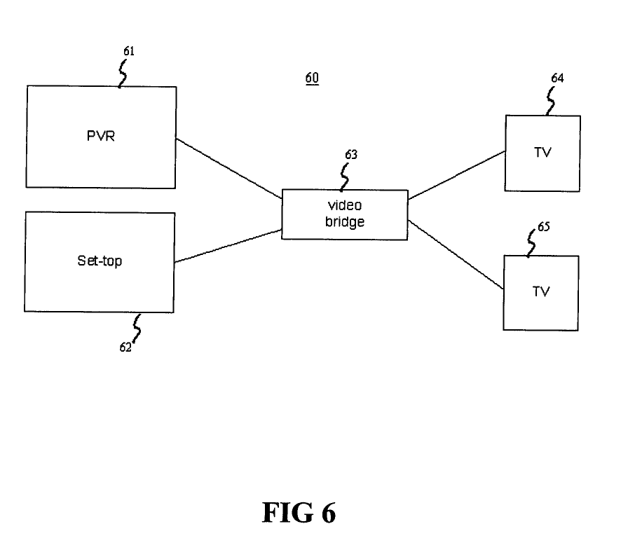

The next embodiment relates to the situation in which there are two servers feeding video that could be sourced to any of two or more clients on different sub networks. FIG. 6 depicts an exemplary embodiment of an apparatus 60 in which there are two servers 61, 62 feeding video over video bridge 63 that can be sourced to any of two or more clients (64, 65) on different sub networks according to still anther aspect of the present invention. All of the sub networks are shown as wired but one or more could be wireless.

There are a few ways to combine these networks. FIG. 7 depicts an exemplary embodiment 70 of a video bridge 63 for use in the apparatus of FIG. 6 according to yet another aspect of the present invention. This embodiment 70 uses two MACs (73, 76 and 74, 77) and two physical interfaces (71, 78 and 72, 79) on each side. As before, a PID filter can be used or the MAC can do the PID filtering. This embodiment 70 employs a multiplexer 75 between the incoming networks and the outgoing networks. This allows both sub networks to take a single stream with all the programs from both incoming streams.

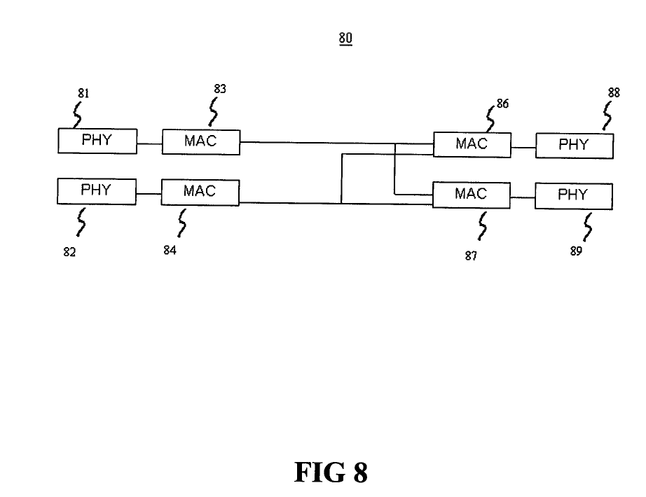

FIG. 8 depicts another exemplary embodiment 80 of a video bridge 63 for use in the apparatus of FIG. 6 according to yet another aspect of the present invention. This embodiment 80 uses two transport stream inputs on the outgoing MACs 83, 84. As with FIG. 7, there are two MACs (83, 86 and 84, 87) and two physical interfaces (81, 88 and 82, 89) on each side. In this case the MUX function would not be required. What has been shown to this point can be extended to support any number of inputs and any number of outputs providing a very flexible networking capability.

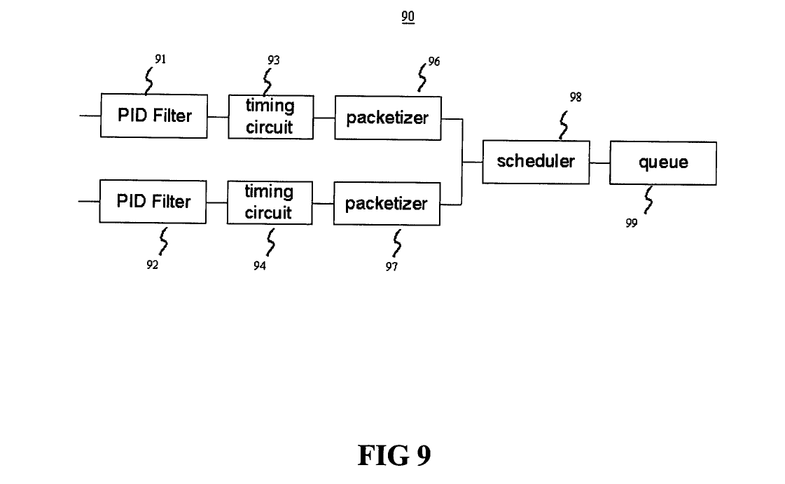

FIG. 9 depicts an exemplary embodiment 90 of a detail of the MAC on the transport side for use in the video bridges 70, 80 of FIGS. 7-8 according to still another aspect of the present invention. The MAC is very similar to the single input embodiment with some of the functions duplicated. The PID Filter 91, 92, the timing circuit 93, 94, and the packetizer 95, 96 are duplicated, one for each channel. There is a single scheduler 98 that schedules the packets from each stream on to the media through the queue 99. The scheduling policy can be hard coded (i.e., first come first served) or the scheduler 95 can be dynamically programmed with a policy. It is also possible for the MAC 90 to use more than one queue to the media in order to allow higher priority traffic to get access ahead of lower priority traffic.

A Television Located in the Middle of the Network

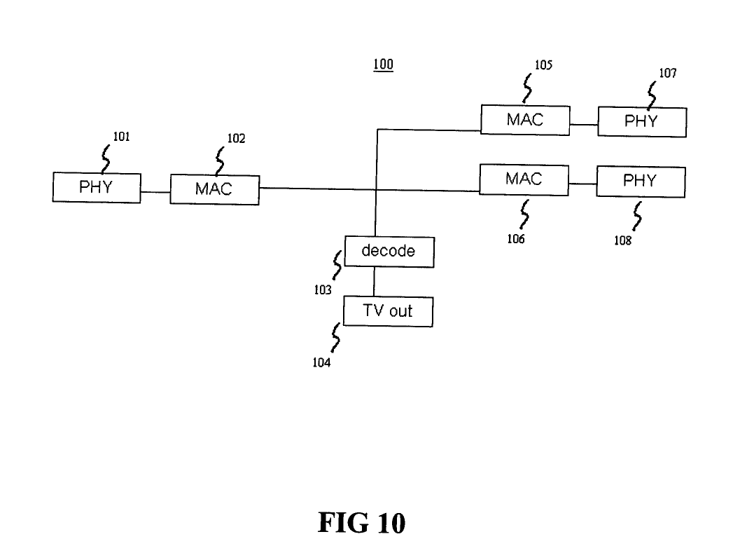

FIG. 10 depicts an exemplary embodiment of an apparatus 100 in which there is a television 104 co-located with the networking device according to still another aspect of the present invention. In this embodiment the TV 104 is co-located with the networking device(s) so a TV output is required to drop off one of the MPEG programs. The embodiment of FIG. 10 shows only a single server, but it could be extended to a multiple server configuration.

Cable Home Management

It is also likely that the MSO would want to manage a device like this and use the Cable Home standard to do it. FIG. 11 shows an exemplary embodiment 110 of how the present inventions can be extended to add CableHome management. No additional external interfaces are required. The Local Processor 119 has a TCP/IP stack and runs the management application. Also note that the downstream MACs 115, 116 are also tied to the data ports. This allows for management of these networks as well. This device could be CableHome compliant yet none of the video interfaces are IP based. This does not violate the CableHome specification because the CableHome specification does not cover the existence of non-IP traffic. Only the IP based traffic would have to be CableHome compliant. As before, there is a physical layer interface 111 and a MAC 112 on the input side, a decoder 113, a television 114, and two MACs, 115, 116 and two physical layer interfaces 117, 118 on the output side.

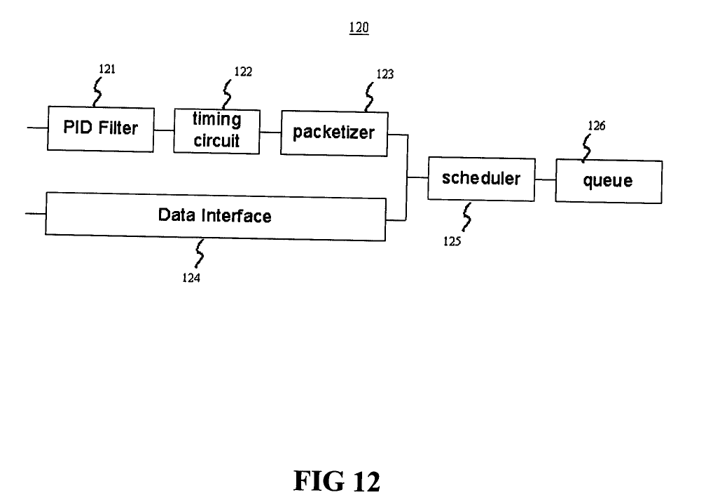

FIG. 12 shows an exemplary embodiment 120 of the transmit MAC 115, 116 with both data and MPEG interfaces in more details. The MPEG path is the same as described previously (i.e., PID filter 121, timing circuit 122, packetizer 123, scheduler 125 and queue 126). The Data path 124 is in parallel with the MPEG path into the scheduler 125. The scheduling policy may be hard coded (i.e., first come first served) or the scheduler 125 may be dynamically programmed with a policy. It is also possible for the MAC to use more than one queue to the media in order to allow higher priority traffic to get access ahead of lower priority traffic.

Data Interfaces

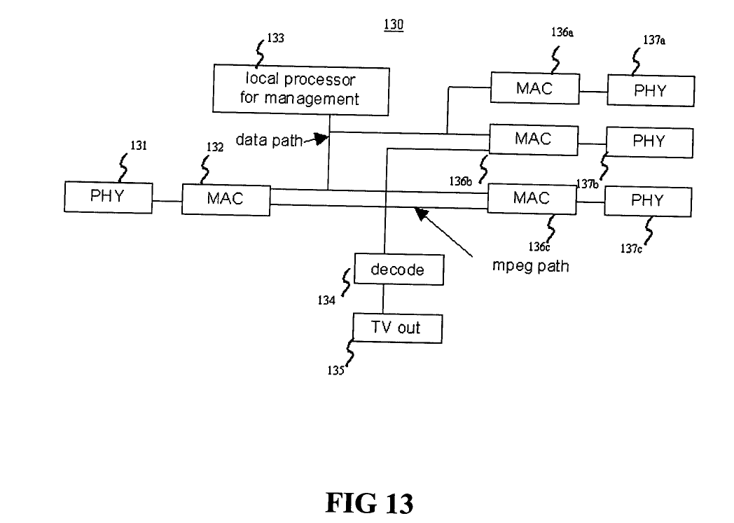

The next embodiment provides data interfaces on a box like this that would also be CableHome compliant interfaces as they would support IP traffic. FIG. 13 depicts an exemplary embodiment 130 of an apparatus similar to that of FIG. 11 with data interfaces that are CableHome compliant interfaces according to still another aspect of the present invention. Basically, another MAC 137a is attached to the data path. The PHY could be any home networking PHY and an extension to this could be to add a bridge and offer any number of data interfaces. Also shown is the ability to run the data interface into the MACs 137b-c that are running video and mix the data and video on the same sub network.

The transmit MAC detail block diagram for data is the same as the CableHome management description above. In both cases we are dealing with IP packets.

Voice

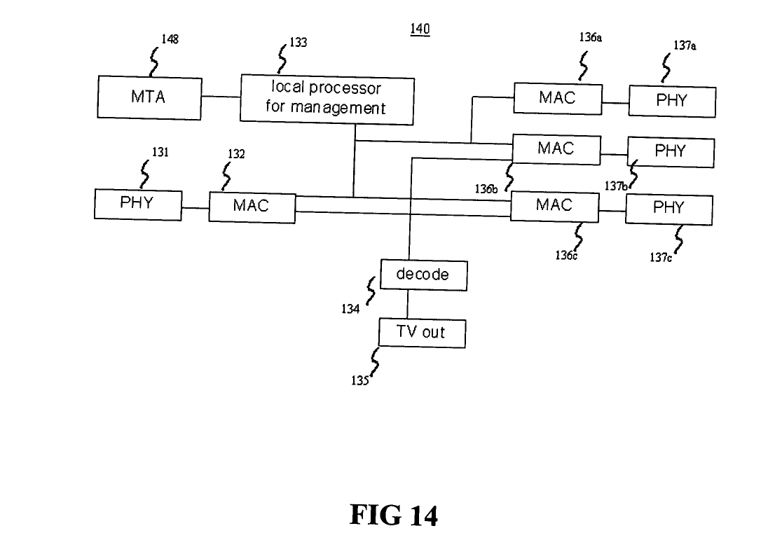

It is also possible to add voice to a product like this by adding the MTA function to the device. FIG. 14 depicts an exemplary embodiment of an apparatus 140 similar to that of FIG. 13 with voice capability according to still another aspect of the present invention. The voice ports could be POTS are they could use one of the home networking interfaces. The Media Terminal Adapter (MTA) performs the Voice-Over-IP (VoIP) processing.

The MTA in FIG. 14 has POTS inputs (could be either wired phones or cordless) and the output from the MTA comprises IP packets. Essentially the MTA acts as a VoIP terminal for POTS phones. In FIG. 12, the MTA could be connected as an input to the data interface block. The output of the MTA is IP packets, which are processed like other IP packets through the data interface. The present invention enables QoS signaling from the MTA to the scheduler. This provides the scheduler the opportunity to schedule both isochronous video traffic and VoIP traffic together over the same home network.

### CONCLUSION

Non-IP based Video networking can be seamlessly added to a CableHome and PacketCable compliant home network. This patent application shows inter alia how these devices can be constructed and how video can be networked across multiple subnets.

It should also be noted that the end user is not aware of which services are run over IP and which are not. Internally the traffics types are physically routed appropriately. The mixing of non-IP video traffic with IP traffic can be accommodated in a clean and inexpensive design.

Although various embodiments are specifically illustrated and described herein, it will be appreciated that modifications and variations of the invention are covered by the above teachings and are within the purview of the appended claims without departing from the spirit and intended scope of the invention. For example, various embodiments are depicted with wireless or wired interfaces, however, in many cases, these interfaces could be wired or wireless, respectively, without departing from the invention. Moreover, examples of timing critical data discussed herein include MPEG data and 1394 traffic containing isochronous video information, however, the inventions herein are applicable to any data in which the timing relationship between successive packets must be maintained or is inherently significant. Furthermore, these examples should not be interpreted to limit the modifications and variations of the invention covered by the claims but are merely illustrative of possible variations.

What is claimed is:

1. A method for transmitting timing critical data over a network that is also carrying Internet Protocol traffic comprising:
transmitting the timing critical data directly to a media access control layer;
maintaining a timing relationship of the timing critical data throughout the media access control layer to a scheduler; and
scheduling transmission of the timing critical data and the Internet Protocol traffic in a single scheduler.

2. The method according to claim 1, wherein the timing critical data comprises an MPEG video data stream.

3. The method according to claim 1, wherein the timing critical data comprises 1394 traffic including isochronous video data.

4. An apparatus to receive timing critical data from a first network and to transmit the timing critical data over one or more other networks to one or more client devices comprising:
a video bridge to couple to the first network, said video bridge receiving the timing critical data, maintaining a timing relationship of the timing critical data and scheduling transmission of the timing critical data over the one or more other networks.

5. The apparatus according to claim 4, wherein the video bridge comprises:
a MAC receiver outputting the timing critical data; and
one or more MAC transmitters, one for each of the one of more client devices, each MAC transmitter coupled to the MAC receiver, receiving the timing critical data and converting the timing critical data to a format suitable for transmission over one of the one or more other networks.

6. The apparatus according to claim 5, wherein the video bridge further comprises:
a first physical layer interface to couple to the first network and coupled to the MAC receiver; and
one or more second physical layer interfaces, each second physical layer interface coupled to one of the one or more MAC transmitters, and each second physical layer interface to couple to said one of the one or more other networks.

7. The apparatus according to claim 5, wherein each of the one or more MAC transmitters comprises:
a timing circuit to adjust timing resulting from any filtering and to add additional timing information to adjust for latency and jitter introduced by said one of the one or more other networks;
a packetizer coupled to the timing circuit to create packets or frames that meet requirements of said one of the one or more other networks; and
a scheduler coupled to the packetizer to schedule access to said one of the one or more other networks.

8. The apparatus according to claim 7, wherein each of the one or more MAC transmitters further comprises:
a PID filter to receive the timing critical data and to filter out programs that are not required by one of the one or more client devices and outputting the filtered timing critical data to the timing circuit; and
a queue coupled to the scheduler to buffer packets or frames prior to transmission over said one of the one or more other networks.

9. The apparatus according to claim 5, further comprising one or more additional MAC receivers, one for each of the one or more client devices, each of the one or more additional MAC receivers disposed between one of the one or more other networks and one of the one or more client devices, wherein each of the one or more additional MAC receivers comprises:
a depacketizer to convert incoming packets to a format suitable for the timing critical data;
a timing circuit coupled to the depacketizer to restore the timing critical data based on bits added by a timing circuit in the one or more MAC transmitters; and
a queue coupled to the depacketizer to buffer incoming packets from said one of the one or more other networks before passing the incoming packets to the depacketizer.

10. The apparatus according to claim 4, wherein the one or more client devices comprises at least two client devices, and the video bridge transmits an identical copy of the timing critical data to each of the at least two client devices.

11. An apparatus for transmitting a first timing critical data from a first network and a second timing critical data from a second network over one or more other networks to one or more client devices comprising:
a video bridge coupled to the first and second networks and receiving the first and second timing critical data from the first and second networks, maintaining a timing relationship of the first and second timing critical data and scheduling transmission of the timing critical data over the one or more other networks to each of the one or more client devices.

12. The apparatus according to claim 11, wherein the video bridge comprises:
a first MAC receiver outputting the first timing critical data;
a second MAC receiver outputting the second timing critical data;
a multiplexer coupled to the first and second MAC receivers and creating a single data stream from the first and second timing critical data; and
one or more MAC transmitters coupled to the multiplexer, one for each of the one or more client devices, each of the one or more MAC transmitters receiving the single data stream including the first and second timing critical data, converting the first and second timing critical data to a format suitable for transmission over the one or more other networks, and filtering out programming not selected by said each of the one or more client devices.

13. The apparatus according to claim 12, wherein the video bridge further comprises:
a first physical layer interface to couple to the first network and coupled to the first MAC receiver;
a second physical layer interface to couple to the second network and coupled to the second MAC receiver; and
one or more other physical layer interfaces, each of which is coupled to one of the one or more MAC transmitters and each is which is also coupled to one of the one or more other networks.

14. The apparatus according to claim 12, wherein each of the one or more MAC transmitters comprises:
a timing circuit to adjust timing resulting from any filtering and to add additional timing information to adjust for latency and jitter introduced by said one of the one or more other networks;
a packetizer coupled to the timing circuit to create packets or frames that meet requirements of said one of the one or more other networks; and
a scheduler coupled to the packetizer to schedule access to said one of the one or more other networks.

15. The apparatus according to claim 14, wherein each of the one or more MAC transmitters further comprises:
a PID filter to receive the single data stream and to filter out programs that are not required by one of the one or more client devices to which said each MAC transmitter is coupled via one of the one or more other networks, and outputting the filtered single data stream to the timing circuit; and
a queue coupled to the scheduler to buffer packets or frames prior to transmission over said one of the one or more other networks.

16. The apparatus according to claim 11, further comprising one or more additional MAC receivers, one for each of the one or more client devices, each of the one or more additional MAC receivers disposed between one of the one or more other networks and one of the one or more client devices, wherein each of the one or more additional MAC receivers comprises:
a depacketizer to convert incoming packets to a format suitable for the first and second timing critical data;
a timing circuit to restore the first and second timing critical data based on bits added by one of the one or more MAC transmitters; and
a queue coupled to the depacketizer to buffer incoming packets from the one or more other networks before passing the incoming packets to the depacketizer.

17. The apparatus according to claim 11, wherein the video bridge comprises:
a first MAC receiver outputting the first timing critical data;
a second MAC receiver outputting the second timing critical data; and
one or more MAC transmitters, one for each of the one or more client devices, each of the one or more MAC transmitters receiving the first timing critical data and the second timing critical data, converting the first and second timing critical data to a format suitable for transmission over the one or more other networks, and filtering out programming not selected by said each of the one or more client devices.

18. The apparatus according to claim 17, wherein the video bridge further comprises:
a first physical layer interface to couple to the first network and coupled to the first MAC receiver;
a second physical layer interface to couple to the second network and coupled to the second MAC receiver; and
one or more other physical layer interfaces, one for each of the one or more MAC transmitters, each of which is coupled to one of the one or more MAC transmitters and each is which is also coupled to one of the one or more other networks.

19. The apparatus according to claim 17, wherein each of the one or more MAC transmitters comprises:
a first timing circuit to adjust timing resulting from any filtering and to add additional timing information to adjust for latency and jitter introduced by said one of the one or more other networks;
a second timing circuit to adjust timing resulting from any filtering and to add additional timing information to adjust for latency and jitter introduced by said one of the one or more other networks;
a first packetizer coupled to the first timing circuit to create packets or frames that meet requirements of said one of the one or more other networks;
a second packetizer coupled to the second timing circuit to create packets or frames that meet requirements of said one of the one or more other networks; and
a scheduler coupled to each of the first and second packetizers to schedule access to said one of the one or more other networks.

20. The apparatus according to claim 19, wherein each of the one or more MAC transmitters further comprises:
a first PID filter to receive the first timing critical data and to filter out programs in the first timing critical data that are not required by one of the one or more client devices to which said each of the one or more MAC transmitters is coupled via one of the one or more other networks, said first PID filter outputting the filtered first timing critical data to the first timing circuit;
a second PID filter to receive the second timing critical data and to filter out programs in the second timing critical data that are not required by one of the one or more client devices to which said each of the one or more MAC transmitters is coupled via one of the one or more other networks, said second PID filter outputting the filtered second timing critical data to the second timing circuit; and
a queue coupled to the scheduler to buffer packets or frames prior to transmission over said one of the one or more other networks.

21. An apparatus for transmitting timing critical data from a first network over one or more other networks to one or more client devices comprising:
a video bridge coupled to the first network and receiving the timing critical data, maintaining a timing relationship of the timing critical data, scheduling transmission of the timing critical data over the one or more other networks, and outputting a television signal; and
a television coupled to the video bridge to receive the television signal from the video bridge.

22. The apparatus according to claim 21, wherein the video bridge comprises:
a MAC receiver outputting the timing critical data;
a decoder coupled to the MAC receiver and the television and converting the timing critical data to a television signal; and
a MAC transmitter receiving the timing critical data and converting the timing critical data to a format suitable for transmission over the network.

23. An apparatus for transmitting timing critical data from a first network along with Internet Protocol packets over one or more other networks to one or more client devices comprising:
a processor outputting Internet Protocol data packets; and
a video bridge coupled to the first network and the processor, receiving the timing critical data, maintaining a timing relationship of the timing critical data and scheduling transmission of the timing critical data along with the Internet Protocol packets over the one or more other networks to the one or more client devices.

24. The apparatus according to claim 23, wherein the video bridge comprises:
a MAC receiver outputting the timing critical data; and
one or more MAC transmitters, one for each of the one or more client devices, each Mac transmitter receiving the timing critical data and converting the timing critical data to a format suitable for transmission over the one or more other networks and having a data port coupled to the processor to receive Internet Protocol packets.

25. The apparatus according to claim 24, wherein each of the one or more MAC transmitters comprises:
a PID filter to receive the timing critical data and to filter out programs that are not required by one of the one or more client devices to which said each MAC transmitter is coupled via one of the one or more other networks;
a timing circuit to adjust timing resulting from the filtering and to add additional timing information to adjust for latency and jitter introduced by said one of the one or more other networks;
a packetizer creating packets or frames that meet requirements of said one of the one or more other networks;
a data interface coupled to the processor to receive Internet Protocol packets from the processor; and
a scheduler coupled to the packetizer and the data interface to schedule access to said one of the one or more other networks for both Internet Protocol packets from the processor and the timing critical data.

26. An apparatus for transmitting timing critical data from a first network along with Voice over Internet Protocol packets over one or more other networks to one or more client devices comprising
a media terminal adapter, having one or more telephone ports for coupling to a telephone device, and outputting Voice over Internet Protocol packets; and
a video bridge coupled to the first network and coupled to the media terminal adapter, receiving the timing critical data, receiving the voice over Internet Protocol packets from the media terminal adapter, maintaining a timing relationship of the timing critical data and scheduling transmission of the timing critical data and the voice over Internet Protocol packets over the one or more other networks to the one or more client devices.

27. The apparatus according to claim 26, wherein the video bridge comprises:
a MAC receiver outputting the timing critical data; and
one or more MAC transmitters, one for each of the one or more client devices, each Mac transmitter receiving the timing critical data and converting the timing critical data to a format suitable for transmission over the one or more other networks and having a data port coupled to the media terminal adapter to receive Voice over Internet Protocol packets.

28. The apparatus according to claim 27, wherein each of the one or more MAC transmitters comprises:
a PID filter to receive the timing critical data and to filter out programs that are not required by one of the one or more client devices to which said each MAC transmitter is coupled via one of the one or more other networks;
a timing circuit to adjust timing resulting from the filtering and to add additional timing information to adjust for latency and jitter introduced by said one of the one or more other networks;
a packetizer creating packets or frames that meet requirements of said one of the one or more other networks;
a data interface coupled to the media terminal adapter to receive voice over Internet Protocol packets from the processor; and
a scheduler coupled to the packetizer and the data interface to schedule access to said one of the one or more other networks for both the voice over Internet Protocol packets from the media terminal adapter and the timing critical data.
